(19) United States
(12) Patent Application Publication
(10) Pub. No.: US 2013/0152017 A1
(43) Pub. Date: Jun. 13, 2013

(54) APPARATUS AND METHOD FOR PROVIDING GRAPHIC USER INTERFACE

(71) Applicants: Byung-youn Song, Suwon-si (KR); Nag-eui Choi, Suwon-si (KR)

(72) Inventors: Byung-youn Song, Suwon-si (KR); Nag-eui Choi, Suwon-si (KR)

(21) Appl. No.: 13/674,833

(22) Filed: Nov. 12, 2012

(30) Foreign Application Priority Data
Dec. 9, 2011 (KR) 10-2011-0132127

(51) Int. Cl. G06F 3/048

(52) U.S. Cl. 715/811

(57) ABSTRACT

Described is an example of an apparatus and method for providing a graphic user interface (GUI). A plurality of icons may be displayed on a screen. A frequency of use of each of the icons displayed on the screen may be stored. Accordingly, an external appearance of at least one icon from among the plurality of icons may be changed to reflect the frequency of use of the plurality of icons.

### CROSS-REFERENCE TO RELATED APPLICATION(S)

This application claims the benefit under 35 USC §119(a) of Korean Patent Application No. 10-2011-0132127, filed on Dec. 9, 2011, in the Korean Intellectual Property Office, the entire disclosure of which is incorporated herein by reference for all purposes.

### BACKGROUND

1. Field

The following description relates to an apparatus and method for providing a graphic user interface (GUI), and more particularly, to an apparatus and method for providing a GUI in which a user's frequency of use is reflected.

2. Description of Related Art

Graphic user interfaces (GUIs) allow a user to conveniently use digital devices. Recently, smart functions such as the Internet, games, social networking services, and other complex functions, are being installed in digital devices such as Blu-ray players, multimedia players, set-top boxes, and the like. Accordingly, a user may input various functions while viewing a GUI to manipulate the digital devices. In various devices, a GUI may be used to rapidly and instinctively transmit information to a user.

For example, GUIs may display various applications, such as the Internet, games, social networking services, and the like, as icons on a screen. A user may move a pointer via devices, such as a keypad, a keyboard, a mouse, or a touch screen, to select an icon pointed to by the pointer, and thus, users may input their desired operations to digital devices.

### SUMMARY

In an aspect, there is provided a method of providing a graphic user interface (GUI), the method including displaying a plurality of icons on a screen, storing a frequency of use of each of the icons displayed on the screen, and changing an external appearance of at least one icon on the screen from among the plurality of icons to reflect the frequency of use of the at least one icon.

The changing of the external appearance of the at least one icon on the screen may be performed after accumulating the frequencies of use of the plurality of icons over a predetermined period of time.

The changing of the external appearance of the at least one icon on the screen may comprise changing at least one of a size, a shape, and a color of the at least one icon on the screen.

In response to a frequency of use of a respective icon from among the plurality of icons being greater than a predetermined upper limit, a size of the respective icon may be enlarged on the screen.

In response to a frequency of use of a respective icon from among the plurality of icons being less than a predetermined lower limit, a size of the respective icon may be reduced on the screen.

The plurality of icons may each comprise a rectangular shape.

The changing of the external appearance of the at least one icon on the screen may comprise changing at least one of an area, a horizontal length, and a vertical length of the plurality of icons on the screen.

The changing of the external appearance of the plurality of icons on the screen may comprise changing a sum of horizontal lengths of the icons that are arranged in a horizontal direction from among the plurality of icons to be equal to or less than a horizontal length of the screen, and changing a sum of vertical lengths of the icons that are arranged in a vertical direction from among the plurality of icons to be equal to or less than a vertical length of the screen.

The frequency of use of each of the icons may be a frequency of selection of the corresponding icon by a request based on a user's manipulation.

In response to a respective icon being selected by a request based on a user's selection, the icon may be enlarged and displayed on the screen for a predetermined period of time or a color of the icon is changed on the screen.

In an aspect, there is provided an apparatus for providing a graphic user interface (GUI), the apparatus including a display unit configured to display a plurality of icons on a screen, an input unit configured to receive a request based on a user's manipulation to manipulate the plurality of icons, a data storage unit configured to store information about a frequency of use of the plurality of icons, and a controller configured to change an external appearance of at least one icon on the screen from among the plurality of icons to reflect the frequency of use of the at least one icon.

The controller may change the external appearance of the at least one icon on the screen after the frequencies of use of the plurality of icons are accumulated over a predetermined period of time.

The changing of the external appearance of the at least one icon on the screen may comprise changing at least one of a size, a shape, and a color of the at least one icon.

The controller may enlarge a size of a respective icon on the screen in response to a frequency of use of the respective icon being greater than a predetermined upper limit.

The controller may reduce a size of a respective icon on the screen in response to a frequency of use of the respective icon being less than a predetermined lower limit.

The plurality of icons may each comprise a rectangular shape.

The changing of the external appearance of the at least one icon on the screen may comprise changing at least one of an area, a horizontal length, and a vertical length of the plurality of icons on the screen.

The changing of the external appearance of the plurality of icons on the screen may comprise changing a sum of horizontal lengths of the icons that are arranged in a horizontal direction from among the plurality of icons to be equal to or less than a horizontal length of the screen, and changing a sum of vertical lengths of the icons that are arranged in a vertical direction from among the plurality of icons to be equal to or less than a vertical length of the screen.

The frequency of use of each of the plurality of icons may be a frequency of selection of the corresponding icon by a request based on a user's manipulation input via the input unit or a frequency of execution of the corresponding icon by the request based on a user's manipulation input via the input unit.

The apparatus may comprise at least one of a smart television (TV), a Blu-ray player, a multimedia player, a set-top box, a personal computer (PC), a game console, a mobile phone, a smart phone, a notebook computer, a terminal for digital broadcasting, a personal digital assistant (PDA), a portable multimedia player (PMP), a navigation device, and a tablet PC.

In an aspect, there is provided a computer-readable storage medium comprising instructions for causing a processor to implement the method described herein.

Other features and aspects may be apparent from the following detailed description, the drawings, and the claims.

### BRIEF DESCRIPTION OF THE DRAWINGS

FIG. 1 is a diagram illustrating an example of an apparatus for providing a graphic user interface (GUI).

FIG. 2 is a diagram illustrating an example of a GUI provided by the apparatus of FIG. 1.

FIG. 3 is a diagram illustrating an example of an operation of the GUI of FIG. 2 of selecting an icon.

FIG. 4 is a diagram illustrating an example of a GUI in which a frequency of use is reflected.

FIG. 5 is a diagram illustrating an example of a method of providing a GUI.

FIG. 6 is a diagram illustrating an example of a method of resetting a size of an icon based on a frequency of use.

FIGS. 7 and 8 are diagrams illustrating examples of resetting a size of an icon based on a frequency of use when the icons do not fit completely on the screen.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following detailed description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

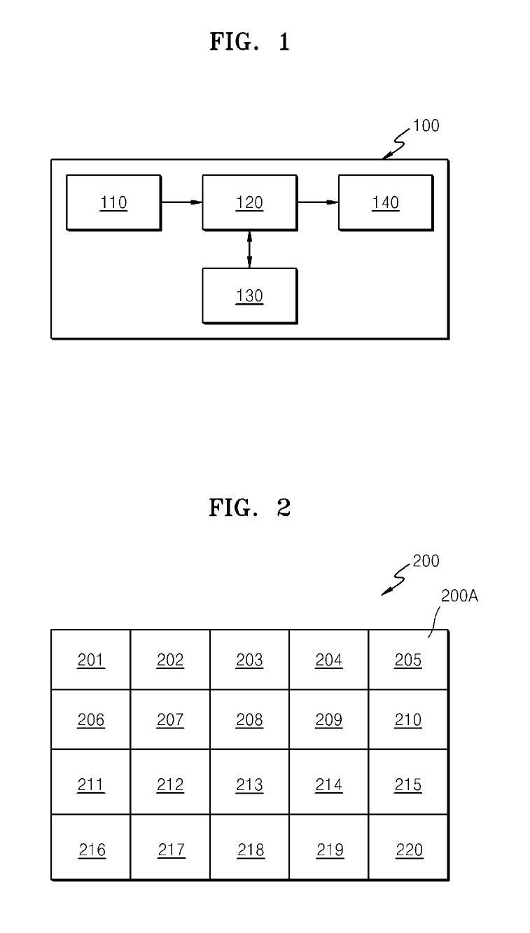

FIG. 1 illustrates an example of a digital apparatus 100 for providing a graphic user interface (GUI).

Referring to FIG. 1, the digital apparatus 100 includes an input unit 110, a controller 120, a data storage unit 130, and a display unit 140.

The input unit 110 may include input device such as key buttons, a touch panel, a mouse, and the like. The input unit 110 receives requests for manipulation that are input by a user and transmits the requests to the controller 120. Some input units, for example, a touch panel, and the display unit 140 may have a layered structure to configure a touch screen.

The controller 120 may provide a user interface based on an operating system (OS). For example, the user interface provided by the controller 120 may be a GUI in which a plurality of icons are arranged. The controller 120 may control selection and/or execution of a corresponding icon with respect to a request based on a user's manipulation that is input via the input unit 110.

The data storage unit 130 may store information about an executable program of a GUI, a size of an icon displayed by the GUI, arrangement, a frequency of use and various setting values, and the like. For example, the frequency of use may include a predetermined period of time for which a frequency of use is accumulated, upper and lower limits of a frequency of use, enlargement and reduction magnifications according to a frequency of use, an enlargement magnification when selecting an icon, and the like.

The data storage unit 130 may temporarily store data that is generated during an operation of the controller 120. The data storage unit 130 may include at least one recording medium that is selected from a group consisting of flash memory, hard disk, multimedia card, card type data storage units (for example, a secure digital (SD) data storage unit, an extreme digital (XD) data storage unit, or the like), random access memory (RAM), static random access memory (SRAM), read-only memory (ROM), electrically erasable programmable read-only memory (EEPROM), and programmable read-only memory (PROM) magnetic data storage units, a magnetic disc, an optical disc, and the like.

The display unit 140 includes an image panel, for example, a liquid crystal panel, an organic light-emitting panel, and the like, and may display the GUI provided by the controller 120.

As an example, the digital apparatus 100 may be a smart television (TV) that includes an operating system to access public broadcasters, cable broadcasters, the Internet, and the like, to execute various executable programs. The smart TV refers to a digital TV that includes an operating system and a function to access the Internet to use various contents, such as video on demand (VOD), games, a searching function, a converged or intelligent service, as well as real-time broadcasts, under a convenient user environment (user interface (UI)/user experience (UX)).

As another example, the digital apparatus 100 may be an apparatus in which the display unit 140 is externally or internally installed in a device such as a Blu-ray player, a multimedia player, a set-top box, a personal computer (PC), a game console, an appliance, and the like. As another example, the digital apparatus 100 may be a mobile terminal such as a mobile phone, a smart phone, a notebook computer, a terminal for digital broadcasting, a personal digital assistant (PDA), a portable multimedia player (PMP), a navigation device, a tablet PC, and the like. It should be appreciated that the GUI used as the digital apparatus 100 may be used in any device which includes a display.

FIG. 2 illustrates an example of a GUI 200 that may be provided by the digital apparatus 100 of FIG. 1.

Referring to FIG. 2, the GUI 200 includes a plurality of icons, for example, first to twentieth icons 201 to 220. For example, the first icon 201 may denote an application for executing a ground wave broadcast, a second icon 202 may denote an application for executing a cable broadcast, a third icon 203 may denote a web browser application, and the fourth to twentieth icons 204 to 220 may denote additional applications which may be different from one another. It should be appreciated that the number of icons and applications described above are for convenience of description, and the examples herein are not limited thereto.

The first to twentieth icons 201 to 220 displayed on a first screen 200A may have various shapes, for example, rectangular shapes having the same size. In this example, the first to twentieth icons 201 to 220 are arranged in a 4-by-5 array to form the first screen 200A having a rectangular shape. As an example, the first to twentieth icons 201 to 220 may be arranged to contact one another. Alternatively, the first to twentieth icons 201 to 220 may be arranged spaced apart from one another.

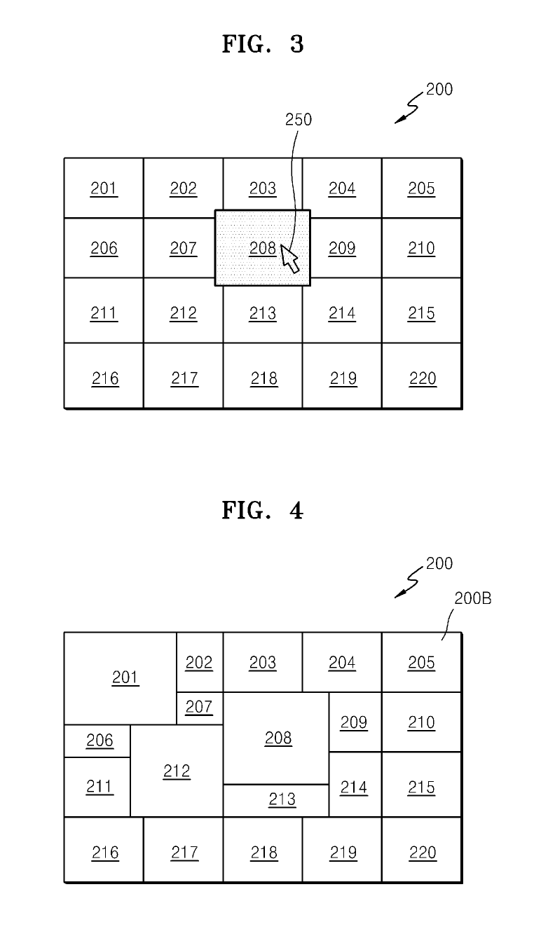

FIG. 3 illustrates an example of an operation of the GUI 200 of FIG. 2 when a user selects an icon.

Referring to FIG. 3, the user may select any an icon (for example, the eighth icon 208) by moving a pointer 250 while the first to twentieth icons 201 to 220 of the GUI 200 are displayed on the display unit 140 (see FIG. 1). The pointer 250 may be moved by manipulating a mouse, a keyboard, or the like. The icon may be selected, for example, by clicking key buttons of a mouse, using a keyboard, or moving the pointer 250 to the corresponding icon for a predetermined period of time. In an example in which the display unit 140 includes a touch screen in which the input unit 110 is integrally coupled to the display unit 140, a user may directly select the icon by tapping their finger or the like on the display unit 140.

When a user selects an icon (for example, the eighth icon 208), the icon may be magnified by a predetermined magnification. As another example, if the user selects an icon (for example, the eighth icon 208), a color of the icon may be changed into a different color. As such, the user may instinctively know that the corresponding icon has been selected by enlarging a size of the icon, changing the color of the icon, a combination thereof, and the like.

Selection and execution of the icon may be distinguished. For example, the execution of the icon refers to execution of an application represented by the icon, whereas selection of the icon may represent readiness of the execution of an application. The user may execute the icon selected by further manipulating, for example, clicking key buttons of a mouse or using a keyboard with respect to the selected icon. As another example, the user may directly execute the icon without performing an operation of selecting the icon when the pointer 250 is positioned at the corresponding icon (for example, the eighth icon 208). Also, in a touch screen in which the input unit 110 is integrally coupled to the display unit 140, for example, the user may directly execute the icon by tapping their finger on the display unit 140 once or twice consecutively without performing an operation of selecting the corresponding icon.

According to various aspects, the number of selecting operations or executing operations of the corresponding icon may be stored as a frequency of use of the icon in the data storage unit 130 (see FIG. 1).

FIG. 4 illustrates an example of a second screen 200B of the GUI 200 in which a frequency of use is reflected.

Referring to FIG. 4, the second screen 200B shows the first to twentieth icons 201 to 220 having various sizes which reflect the frequency of use. For example, the first, eighth, and twelfth icons 201, 208, and 212 are enlarged compared to their initial sizes. This may be used to illustrate that the first, eighth, and twelfth icons 201, 208, and 212 have a greater frequency of use than a predetermined upper limit for a predetermined period of time, for example, a case where the first, eighth, and twelfth icons 201, 208, and 212 are used more than ten times over the course of one month. In addition, as the frequency of use increases, the size of the icon may be increased, thereby allowing the first, eighth, and twelfth icons 201, 208, and 212 to have various sizes.

In this example, the sizes of the second, sixth, seventh, ninth, eleventh, thirteenth, and fourteenth icons 202, 206, 207, 209, 211, 213, and 214 are decreased compared to their initial sizes. This may be used to show that the second, sixth, seventh, ninth, eleventh, thirteenth, and fourteenth icons 202, 206, 207, 209, 211, 213, and 214 have less frequency of use than a predetermined lower limit for a predetermined period of time, for example, a case in which the second, sixth, seventh, ninth, eleventh, thirteenth, and fourteenth icons 202, 206, 207, 209, 211, 213, and 214 are used less than once during the course of one month. In addition, as the frequency of use decreases, the size of the icon may be further decreased, thereby allowing the second, sixth, seventh, ninth, eleventh, thirteenth, and fourteenth icons 202, 206, 207, 209, 211, 213, and 214 to have various sizes.

The third, fourth, fifth, tenth, and fifteenth to twentieth icons 203, 204, 205, 210, and 215 to 220 maintain their initial sizes. This may be used to illustrate that the third, fourth, fifth, tenth, and fifteenth to twentieth icons 203, 204, 205, 210, and 215 to 220 have a frequency of use between the predetermined upper and lower limits for a predetermined period of time, for example, a case in which the third, fourth, fifth, tenth, and fifteenth to twentieth icons 203, 204, 205, 210, and 215 to 220 are used from one to ten times during the course of one month.

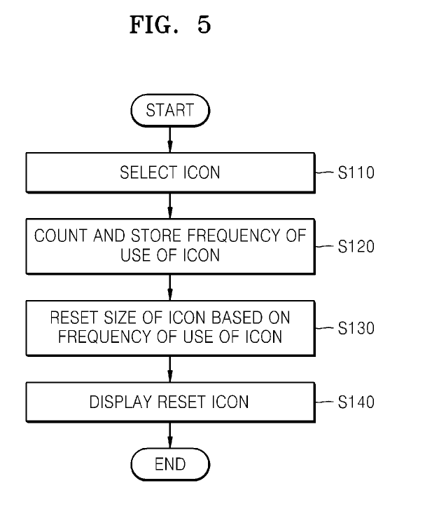

FIG. 5 illustrates an example of a method of providing the GUI 200.

Referring to FIG. 5, the input unit 110 receives a request for selecting an icon from among a plurality of icons displayed on the display unit 140 (operation S110). The controller 120 counts a frequency of use of the selected icon and stores information regarding the frequency of use in the data storage unit 130 (operation S120). Operations S110 and S120 may be repeatedly performed for a predetermined period of time, thereby accumulating the frequency of use of the icons. For example, the predetermined period of time may be determined by default or by a user's selection.

After the predetermined period of time has elapsed, if a user reloads a GUI, the controller 120 resets a size of the icon based on the frequency of use of the icon (operation S130), and the reset icon size is displayed on the display unit 140 (operation S140).

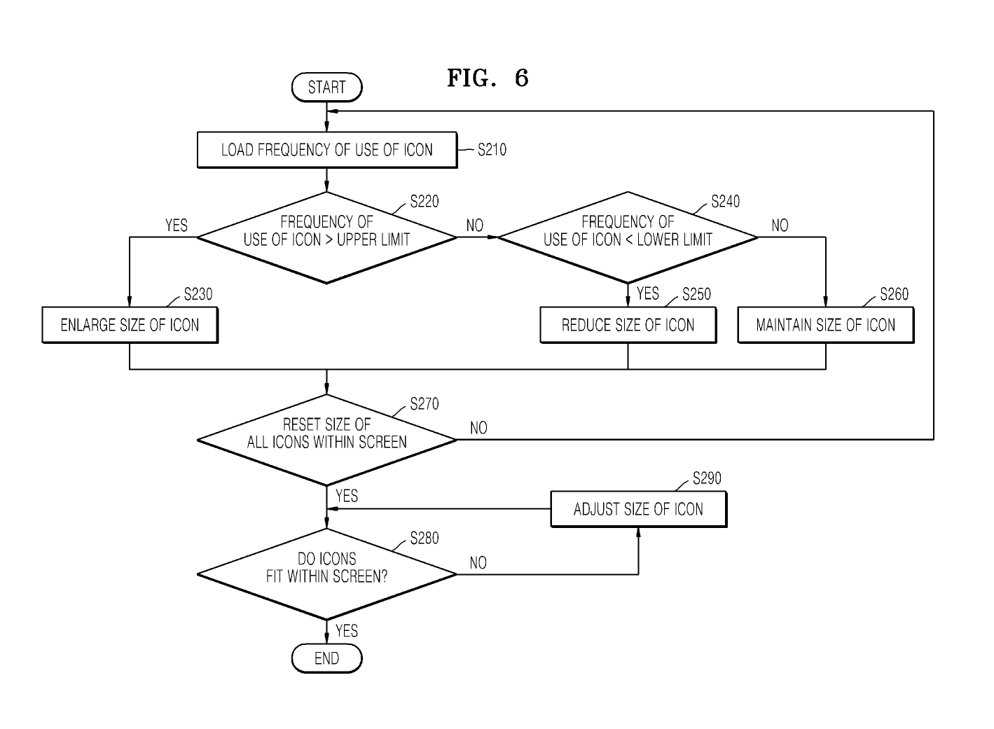

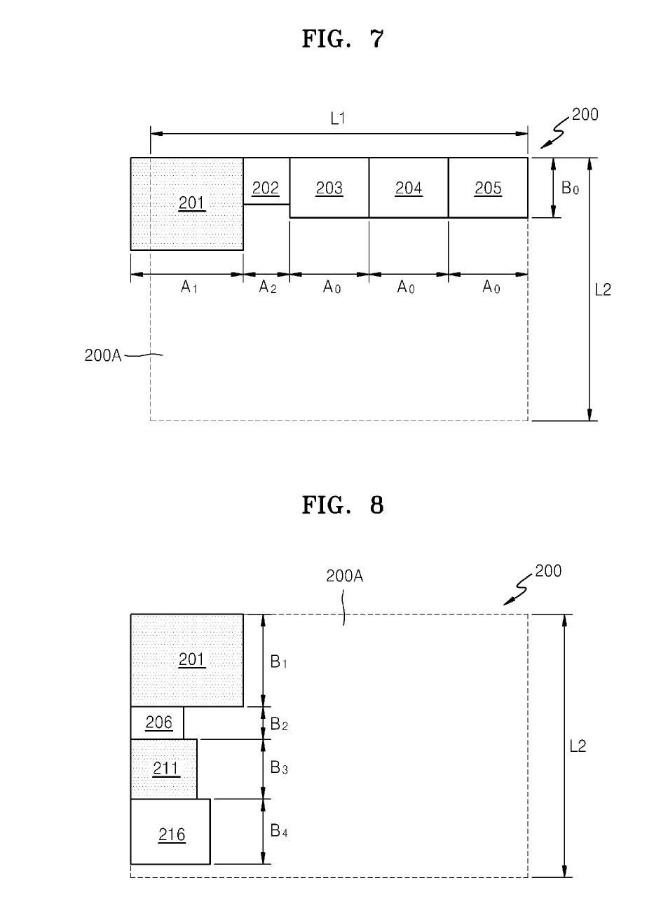

FIG. 6 illustrates an example of a method of resetting a size of an icon based on a frequency of use. FIGS. 7 and 8 are diagrams illustrating examples of screens before reset icons fit when resetting a size of an icon based on a frequency of use.

Referring to FIGS. 1 and 6, after a predetermined period of time has elapsed, if a user reloads a GUI, the controller 120 loads information about a frequency of use of an icon from among a plurality of icons stored in the data storage unit 130 (operation S210). The controller 120 compares the frequency of use of the icon and a predetermined frequency of use (operation S220).

If the frequency of use of the icon is greater than an upper limit, a size of the icon is enlarged (operation S230). An enlargement magnification of the icon may be previously determined. As another example, if the frequency of use of the icon is less than the upper limit, a lower limit of the frequency of use of the corresponding icon is compared with a lower limit of the predetermined frequency of use (operation S240). If the frequency of use of the corresponding icon is less than a lower limit, the size of the corresponding icon is reduced (operation S250), and if the frequency of use of the corresponding icon is equal to or greater than the lower limit, the size of the corresponding icon is maintained (operation S260).

For example, enlargement and reduction magnifications may vary according to the frequency of use of the icon. The enlargement and reduction magnifications may be fixed. Even though the enlargement and reduction magnifications may be fixed, the size of the icon may be repeatedly enlarged or reduced whenever a process of resetting the size of the icon is performed, and thus, the size of the icon may vary. Also, an enlargement magnification of the icon in a horizontal direction and an enlargement magnification of the icon in a vertical direction may be different from or the same as each other. As an example, only a horizontal length or a vertical length of the icon may be enlarged or reduced.

The process of resetting the size of the icon, including operations S210 to S260, may be repeatedly performed on all icons displayed on the display unit 140 (operation S270). If the process of resetting the size of the icon is performed on all icons, it is determined whether the reset icons fit within a screen (operation S280).

FIGS. 7 and 8 illustrate examples in which reset icons do not fit within a screen when resetting the icons based on a frequency of use.

Referring to FIG. 7, the first screen 200A has a horizontal length L1 and a vertical length L2 before resetting of the GUI 200. A horizontal length of each of the first to twentieth icons 201 to 220 before resetting of the GUI 200 is represented by A₀, and a vertical length of each of the first to twentieth icons 201 to 220 before resetting of the GUI 200 is represented by B₀. In this example, a result of the process of resetting the size of the icon, including operations S210 to S260, is that the horizontal length of the first icon 201 is enlarged to A₁, the horizontal length of the second icon 202 is reduced to A₂, and the horizontal lengths of the third to fifth icons 203 to 205 are maintained A₀. As shown in the example of FIG. 7, when a degree of enlargement of the horizontal length of the icon is greater than a degree of reduction of the horizontal length of the icon, the sum of the horizontal lengths of the first to fifth icons 201 to 205 that are arranged in the horizontal direction may be greater than the horizontal length of the first screen 200A before resetting of the GUI 200.

As shown in FIG. 7, if the reset icons deviate from a size of a screen, a process (operation S290 of FIG. 6) of adjusting the size of the icon may be repeatedly performed to fit the icons within the size of the screen. For example, a process of reducing the horizontal lengths of the first to fifth icons 201 to 205 by a predetermined magnification is performed (operation S290). As another example, in a state in which the horizontal lengths of the first to fifth icons 201 to 205 are maintained and are not changed, only the horizontal lengths of the first and second icons 201 and 202 that are changed in size may be reduced by a predetermined magnification.

When the horizontal lengths of the first to fifth icons 201 to 205 are reduced by a predetermined magnification, vertical lengths of the first to fifth icons 201 to 205 may be enlarged by a predetermined magnification to maintain the sizes of areas of the first to fifth icons 201 to 205.

Referring to FIG. 8, as a result of the process of resetting the size of the icon, including operations S210 to S260, the vertical length of the first icon 201 is enlarged to B₁, the vertical length of the sixth icon 206 is reduced to B₂, the vertical length of the eleventh icon 211 is reduced to B₃, and the vertical length of the sixteenth icon 216 is maintained at B₀. As shown in FIG. 8, when a degree of reduction in the vertical length of the icon is greater than a degree of enlargement in the vertical length of the icon, the sum of the vertical lengths of the first, sixth, eleventh, and sixteenth icons 201, 206, 211, and 216 that are arranged in a vertical direction may be less than the overall vertical length of the first screen 200A before resetting of the GUI 200.

As shown in FIG. 8, if sizes of the reset icons are smaller than a size of a screen, a process (operation S290) of adjusting the size of the icon may be repeatedly performed to fit the icons within the size of the screen. For example, a process of enlarging the vertical lengths of the first, sixth, eleventh, and sixteenth icons 201, 206, 211, and 216 by a predetermined magnification may be performed (operation S290). As another example, in a state in which the vertical length of the sixteenth icon 216 is maintained and not changed in size, only the vertical lengths of the first, sixth, and eleventh icons 201, 206, and 211 that are changed in size may be enlarged by a predetermined magnification.

As another example, as shown in FIG. 8, when the sizes of the reset icons are smaller than the size of the screen, the reset icons may not be adjusted, and thus, the vertical lengths of the reset icons may be maintained without performing any additional adjustment.

Referring again to FIG. 6, the process (operation S290) of adjusting the size of the icon may be repeatedly performed until the icons fit within the size of the screen. A final result may be adjusted to a state in which all icons are arranged without a gap, as shown in FIG. 4, but the examples herein are not limited thereto. For computing performance of the controller 120 (see FIG. 1), the process (operation S290) of adjusting the size of the icon may be repeatedly performed a predetermined number of times and then stopped.

As described herein, if the icons fit within the size of the screen, the process of resetting the sizes of the icons is finished. The process of resetting the sizes of the icons described with reference to FIGS. 6 to 8 is just an example, and various algorithms may be used. For example, in addition to the process of resetting the sizes of the icons by reflecting a frequency of use, a process of adjusting a size of each individual icon or arrangement of icons may be additionally performed by direct user manipulation.

In the above-described examples, the first to twentieth icons 201 to 220 displayed on the first screen 200A before reflecting a frequency of use have the same size, but the examples herein are not limited thereto. For example, the first to twentieth icons 201 to 220 displayed on the first screen 200A before reflecting a frequency of use may have various sizes. For example, icons expected to have a high frequency of use may be displayed as large icons, and a process of resetting sizes of icons may be performed.

Also, in the above-described examples, the icons have a rectangular shape, but the examples herein are not limited thereto. For example, the icons may have any of various shapes, and in this case, all icons may be disposed not to contact one another.

According to various aspects, the sizes of the icons may vary according to a frequency of use, but the examples herein are not limited thereto. For example, as a frequency of use increases, an icon may be changed to have a shape having a higher visibility, for example, a polygonal shape having a sharper edge. Likewise, as the frequency of use decreases, an icon may be changed to have a shape having a lower visibility, for example, a polygonal shape having a rounded edge.

As another example, as the frequency of use increases, the icon may be changed to have a color that has a higher visibility, and as the frequency of use decreases, the icon may be changed to have a color that has a lower visibility. As such, a size, a shape, and/or a color of an icon form an external appearance of the icon, and thus, user convenience may be improved by changing the icon to have an external appearance that has a higher visibility as the frequency of use increases and/or by changing the icon to have an external appearance that has a lower visibility as the frequency of use decreases.

Program instructions to perform a method described herein, or one or more operations thereof, may be recorded, stored, or fixed in one or more computer-readable storage media. The program instructions may be implemented by a computer. For example, the computer may cause a processor to execute the program instructions. The media may include, alone or in combination with the program instructions, data files, data structures, and the like. Examples of computer-readable storage media include magnetic media, such as hard disks, floppy disks, and magnetic tape; optical media such as CD ROM disks and DVDs; magneto-optical media, such as optical disks; and hardware devices that are specially configured to store and perform program instructions, such as read-only memory (ROM), random access memory (RAM), flash memory, and the like. Examples of program instructions include machine code, such as produced by a compiler, and files containing higher level code that may be executed by the computer using an interpreter. The program instructions, that is, software, may be distributed over network coupled computer systems so that the software is stored and executed in a distributed fashion. For example, the software and data may be stored by one or more computer readable storage mediums. Also, functional programs, codes, and code segments for accomplishing the example embodiments disclosed herein can be easily construed by programmers skilled in the art to which the embodiments pertain based on and using the flow diagrams and block diagrams of the figures and their corresponding descriptions as provided herein. Also, the described unit to perform an operation or a method may be hardware, software, or some combination of hardware and software. For example, the unit may be a software package running on a computer or the computer on which that software is running.

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A method of providing a graphic user interface (GUI), the method comprising:
displaying a plurality of icons on a screen;
storing a frequency of use of each of the icons displayed on the screen; and
changing an external appearance of at least one icon on the screen from among the plurality of icons to reflect the frequency of use of the at least one icon.

2. The method of claim 1, wherein the changing of the external appearance of the at least one icon on the screen is performed after accumulating the frequencies of use of the plurality of icons over a predetermined period of time.

3. The method of claim 1, wherein the changing of the external appearance of the at least one icon on the screen comprises changing at least one of a size, a shape, and a color of the at least one icon on the screen.

4. The method of claim 1, wherein, in response to a frequency of use of a respective icon from among the plurality of icons being greater than a predetermined upper limit, a size of the respective icon is enlarged on the screen.

5. The method of claim 1, wherein, in response to a frequency of use of a respective icon from among the plurality of icons being less than a predetermined lower limit, a size of the respective icon is reduced on the screen.

6. The method of claim 1, wherein the plurality of icons each comprise a rectangular shape.

7. The method of claim 6, wherein the changing of the external appearance of the at least one icon on the screen comprises changing at least one of an area, a horizontal length, and a vertical length of the plurality of icons on the screen.

8. The method of claim 6, wherein the changing of the external appearance of the plurality of icons on the screen comprises changing a sum of horizontal lengths of the icons that are arranged in a horizontal direction from among the plurality of icons to be equal to or less than a horizontal length of the screen, and changing a sum of vertical lengths of the icons that are arranged in a vertical direction from among the plurality of icons to be equal to or less than a vertical length of the screen.

9. The method of claim 1, wherein the frequency of use of each of the icons is a frequency of selection of the corresponding icon by a request based on a user's manipulation.

10. The method of claim 1, wherein, in response to a respective icon being selected by a request based on a user's selection, the icon is enlarged and displayed on the screen for a predetermined period of time or a color of the icon is changed on the screen.

11. An apparatus for providing a graphic user interface (GUI), the apparatus comprising:
a display unit configured to display a plurality of icons on a screen;
an input unit configured to receive a request based on a user's manipulation to manipulate the plurality of icons;
a data storage unit configured to store information about a frequency of use of the plurality of icons; and
a controller configured to change an external appearance of at least one icon on the screen from among the plurality of icons to reflect the frequency of use of the at least one icon.

12. The apparatus of claim 11, wherein the controller changes the external appearance of the at least one icon on the screen after the frequencies of use of the plurality of icons are accumulated over a predetermined period of time.

13. The apparatus of claim 11, wherein the changing of the external appearance of the at least one icon on the screen comprises changing at least one of a size, a shape, and a color of the at least one icon.

14. The apparatus of claim 11, wherein the controller enlarges a size of a respective icon on the screen in response to a frequency of use of the respective icon being greater than a predetermined upper limit.

15. The apparatus of claim 11, wherein the controller reduces a size of a respective icon on the screen in response to a frequency of use of the respective icon being less than a predetermined lower limit.

16. The apparatus of claim 11, wherein the plurality of icons each comprise a rectangular shape.

17. The apparatus of claim 15, wherein the changing of the external appearance of the at least one icon on the screen comprises changing at least one of an area, a horizontal length, and a vertical length of the plurality of icons on the screen.

18. The apparatus of claim 15, wherein the changing of the external appearance of the plurality of icons on the screen comprises changing a sum of horizontal lengths of the icons that are arranged in a horizontal direction from among the plurality of icons to be equal to or less than a horizontal length of the screen, and changing a sum of vertical lengths of the icons that are arranged in a vertical direction from among the plurality of icons to be equal to or less than a vertical length of the screen.

19. The apparatus of claim 11, wherein the frequency of use of each of the plurality of icons is a frequency of selection of the corresponding icon by a request based on a user's manipulation input via the input unit or a frequency of execution of the corresponding icon by the request based on a user's manipulation input via the input unit.

20. The apparatus of claim 11, wherein the apparatus comprises at least one of a smart television (TV), a Blu-ray player, a multimedia player, a set-top box, a personal computer (PC), a game console, a mobile phone, a smart phone, a notebook computer, a terminal for digital broadcasting, a personal digital assistant (PDA), a portable multimedia player (PMP), a navigation device, and a tablet PC.

21. A computer-readable storage medium comprising instructions for causing a processor to implement the method of claim 1.
